(19) United States
(12) Patent Application Publication
(10) Pub. No.: US 2014/0369171 A1
(43) Pub. Date: Dec. 18, 2014

(54) ELECTRONIC CLOCK

(71) Applicant: CHOU WEN HUNG, Taichung (TW)

(72) Inventor: CHOU WEN HUNG, Taichung (TW)

(21) Appl. No.: 14/068,000

(22) Filed: Oct. 31, 2013

(30) Foreign Application Priority Data
Jun. 14, 2013 (TW) 102211155

(51) Int. Cl. G04G 9/00; G04G 19/10; G04G 17/08

(52) U.S. Cl. CPC G04G 9/00; G04G 17/08; G04G 19/10
USPC 368/64; 368/88; 368/83; 368/84; 368/67

(57) ABSTRACT

An electronic clock contains a clock module with at least one display panel and a transforming module. The transforming module is mounted in a power supply space of at least one switch on a wall. The clock module is fitted on a rear end of each switch, and the at least one display panel correspond to a displaying portion of each switch. The transforming module is electrically connected with supply mains in the power supply space of the at least one switch so as to output power to the clock module. The at least one display panel is electrically connected with the clock module, and the clock module is electrically coupled with the transforming module so as to receive power outputted by the transforming module, hence the clock module produces electronic signals to display time or/and date on the at least one display panel.

### FIELD OF THE INVENTION

The present invention relates to an electronic clock in which at least one display panel of a clock module generates at least one display mode for corresponding to a number of at least one switch on a wall.

### BACKGROUND OF THE INVENTION

Conventional electronic clock is hanged on a wall or is fixed on a table desk, but it falls off the wall or the table easily. Likewise, the conventional electronic clock stops operation after running out of power of a battery.

The present invention has arisen to mitigate and/or obviate the afore-described disadvantages.

### SUMMARY OF THE INVENTION

The primary object of the present invention is to provide an electronic clock in which at least one display panel of a clock module generates at least one display mode for corresponding to a number of at least one switch on a wall.

To obtain the above objective, an electronic clock provided by the present invention contains: a clock module with at least one display panel and a transforming module.

The transforming module is mounted in a power supply space of at least one switch on a wall.

The clock module is fitted on a rear end of each switch, and the at least one display panel correspond to a displaying portion of each switch.

The transforming module is electrically connected with supply mains in the power supply space of the at least one switch so as to output power to the clock module.

The at least one display panel is electrically connected with the clock module, and the clock module is electrically coupled with the transforming module so as to receive power outputted by the transforming module, hence the clock module produces electronic signals to display time or/and date on the at least one display panel.

Thereby, the electronic clock of the present invention also has the following advantages:

1. The clock module is fitted on at least one switch on the wall, and the at least one display panel corresponds to the at least one displaying portion of the at least one switch, such that the clock module is connected with the at least one switch to display the time or/and the date.

2. The clock module is connected with the at least one switch on the wall securely.

3. The supply mains supplies power to the clock module so that the electronic clock operates stably. In addition, the electronic clock further comprises the power backup module to supply power when a power failure occurs.

4. The at least one display panel of the clock module cooperates with different numbers of switches based on using requirement.

### BRIEF DESCRIPTION OF THE DRAWINGS

FIG. 1 is a perspective view showing the application of an electronic clock according to a preferred embodiment of the present invention.

FIG. 2 is a perspective view showing the assembly of the electronic clock according to the preferred embodiment of the present invention.

FIG. 3 is another perspective view showing the assembly of the electronic clock according to the preferred embodiment of the present invention.

FIG. 4 is also another perspective view showing the assembly of the electronic clock according to the preferred embodiment of the present invention.

FIG. 5 is still another perspective view showing the assembly of the electronic clock according to the preferred embodiment of the present invention.

FIG. 6 is also another perspective view showing the assembly of the electronic clock according to the preferred embodiment of the present invention.

FIG. 7 is also another perspective view showing the assembly of the electronic clock according to the preferred embodiment of the present invention.

FIG. 8 is also another perspective view showing the assembly of the electronic clock according to the preferred embodiment of the present invention.

FIG. 9 is also another perspective view showing the assembly of the electronic clock according to the preferred embodiment of the present invention.

### DETAILED DESCRIPTION OF THE PREFERRED EMBODIMENTS

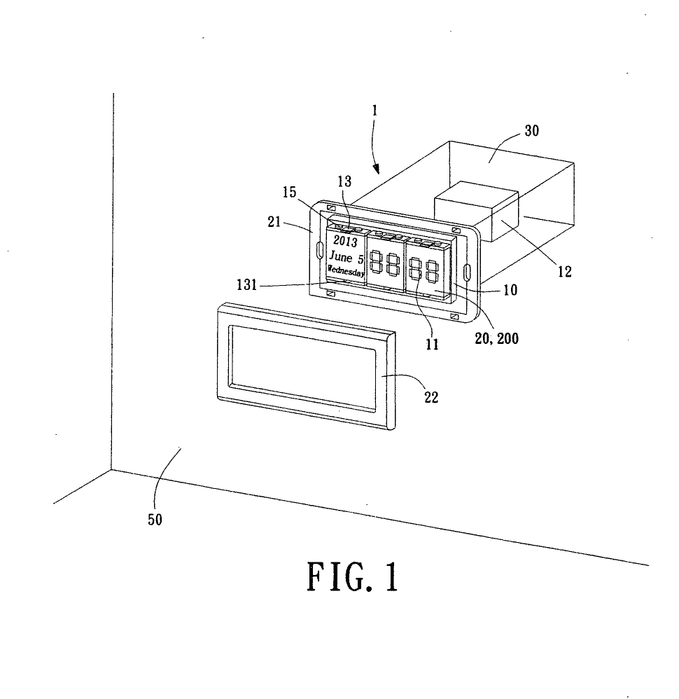

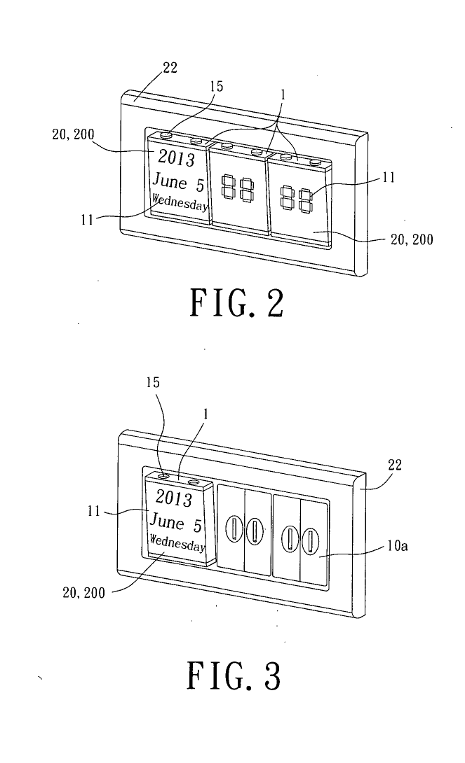

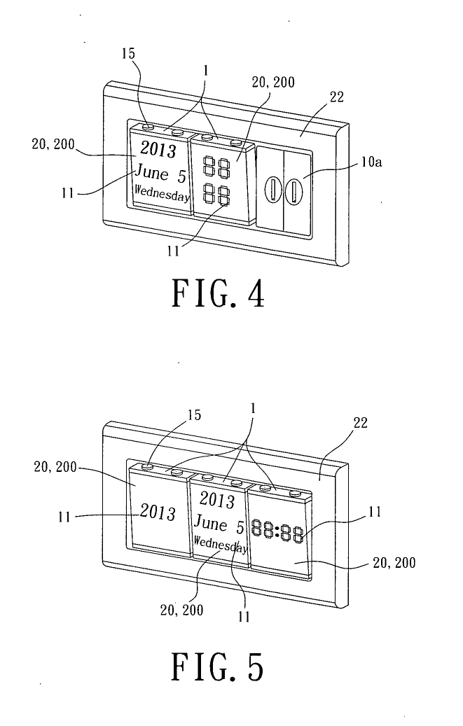

With reference to FIGS. 1 and 2, an electronic clock 1 according to a preferred embodiment of the present invention is fixed on at least one switch 20 on a wall 50 and comprises: a clock module 10 with at least one display panel 11 and a transforming module 12 mounted in a power supply space 30 of the at least one switch 20 on the wall 50. The clock module 10 is fitted on a rear end of each switch 20, and the at least one display panel 11 correspond to a displaying portion 200 of each switch 20; wherein the displaying portion 200 is transparent or is hollow so that time or/and date displayed on the at least one display panel 11 are viewed clearly, wherein when the displaying portion 200 is hollow, a transparent layer is attached on the displaying portion 200 so as to protect the displaying portion 200. The transforming module 12 is electrically connected with supply mains in the power supply space 30 of the at least one switch 20 so as to output power to the clock module 10. For example, when the supply mains is 110 volts and a power supplied to the clock module 10 is 12 volts, the transforming module 12 is a transformer rectifier for transforming 100 volts of alternating currents into 12 volts of direct currents. The at least one display panel 11 is electrically connected with the clock module 10, and the clock module 10 is electrically coupled with the transforming module 12 so as to receive power outputted by the transforming module 12, hence the clock module 10 produces electronic signals to display the time or/and the date on the at least one display panel 11. The clock module 10 further includes at least one first adjusting button 15 for adjusting the electronic signals produced by the clock module 10, at least one illumination module 13 electrically connected with the clock module 10 and used to illuminate the time or/and the date displayed on the at least one display panel 11. Each illuminating module 13 has a second adjusting button 131 for turning on/off each illuminating module 13 and for adjusting a brightness of each illuminating module 13. The electronic clock 1 further comprises a holder 21 with an opening and a frame 22, wherein the holder 21 is used to fix the clock module 10 and the at least one switch 20 on the wall 50, and the frame 22 is fitted on the at least one switch 20 so as to enhance aesthetics appearance. Each display panel 11 is comprised of any one of LED, LCD, OLED, and AMOLED. Each illuminating module 13 is comprised of any one of a LED light and a light emitting element so as to illumine each display panel 11 or indoor environment. The electronic clock 1 further comprises at least one power backup module, and each power backup module is a rechargeable battery electrically connected with the supply mains or the transforming module, such that when the transforming module 12 cannot supply power toward the clock module 10 via the supply mains, the power backup module supplies stored power to the clock module 10. Preferably, the electronic clock 1 has time alarming function and hourly time announcement. Referring further to FIGS. 3-5, the at least one display panel 11 of the clock module 10 generates at least one display mode for corresponding to a number of the at least one switch 20 on the wall. For example, as shown in FIG. 3, when the clock module 10 is fitted on a rear end of a switch 20, a display panel 11 completely corresponds to a displaying portion 200 of the switch 20, and two power sockets 10a match with the switch 20. As illustrated in FIG. 4, two display panels 11 of the clock module 10 correspond to two displaying portions 200 of two switches 20, and a power socket 10a match with the two switches 20. With reference to FIG. 5, three display panels 11 of the clock module 10 correspond to three displaying portions 200 of three switches 20. Furthermore, each first adjusting button 15 is flat, concaved, or projected to comply with different using requirement.

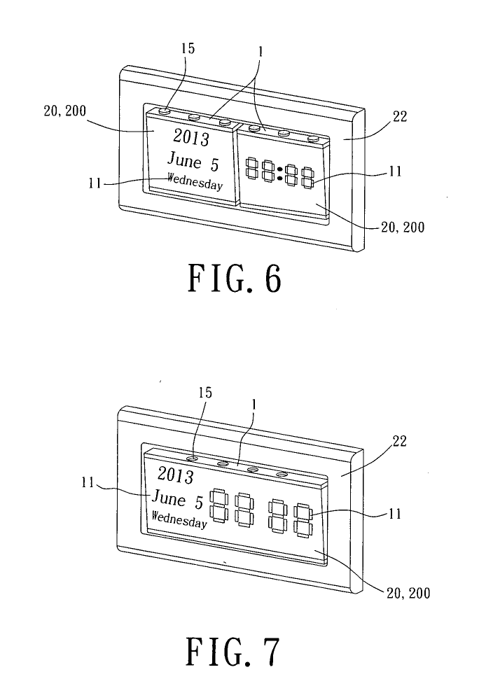

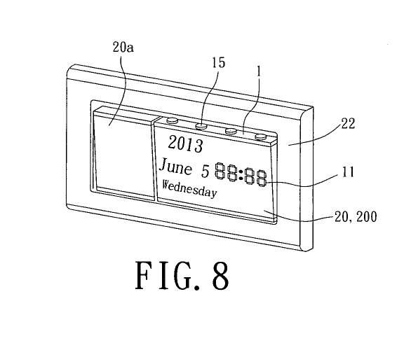

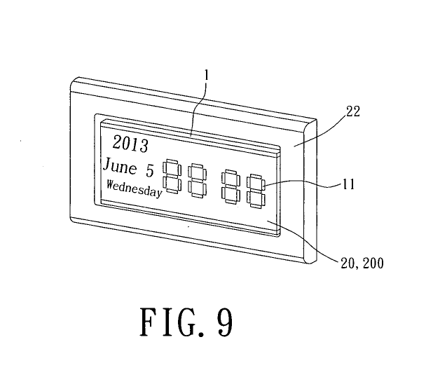

As illustrated in FIG. 6, when the clock module 10 is fitted on two rear ends of two switches 20, and two display panels 11 correspond to the two displaying portions 200 of the two switches 20. As shown in FIG. 7, a display panel 11 corresponds to a displaying portion 200 of a switch 20, and no any power controller 10a is provided to match with one switch 20. With reference to FIG. 8, a display panel 11 of the clock module 10 corresponds to a displaying portion 200 of a switch 20, and a power controller 10a matches with the switch 20. Preferably, each switch 20 is a press switch (as shown in FIGS. 1-8) or is a touch panel (as illustrated in FIG. 9).

Thereby, the electronic clock of the present invention has the following advantages:

1. The clock module is fitted on at least one switch on the wall, and the at least one display panel corresponds to the at least one displaying portion of the at least one switch, such that the clock module is connected with the at least one switch to display any one of the time, the date, and the time and the date.

2. The clock module is connected with the at least one switch on the wall securely.

3. The supply mains supplies power to the clock module so that the electronic clock operates stably. In addition, the electronic clock further comprises the power backup module to supply power when a power failure occurs.

4. The at least one display panel of the clock module cooperates with different numbers of switches based on using requirement.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An electronic clock comprising:
a clock module with at least one display panel and a transforming module; wherein
the transforming module is mounted in a power supply space of at least one switch on a wall;
the clock module is fitted on a rear end of each switch, and the at least one display panel correspond to a displaying portion of each switch;
the transforming module is electrically connected with supply mains in the power supply space of the at least one switch so as to output power to the clock module;
the at least one display panel is electrically connected with the clock module, and the clock module is electrically coupled with the transforming module so as to receive power outputted by the transforming module, hence the clock module produces electronic signals to display any one of time, date, and time and date on the at least one display panel.

2. The electronic clock as claimed in claim 1, wherein the at least one display panel of the clock module generates at least one display mode for corresponding to a number of the at least one switch on the wall.

3. The electronic clock as claimed in claim 1, wherein the clock module includes at least one first adjusting button for adjusting the electronic signals produced by the clock module.

4. The electronic clock as claimed in claim 1 further comprising a holder with an opening and a frame, wherein the holder is used to fix the clock module and the at least one switch on the wall.

5. The electronic clock as claimed in claim 1 further comprising a frame used to fix the clock module and the at least one switch on the wall.

6. The electronic clock as claimed in claim 1, wherein each display panel is comprised of any one of LED, LCD, OLED, and AMOLED.

7. The electronic clock as claimed in claim 1 further comprising at least one power backup module; and each power backup module is electrically connected with the supply mains or the transforming module, such that when the transforming module cannot supply power toward the clock module via the supply mains, the power backup module supplies stored power to the clock module.

8. The electronic clock as claimed in claim 1, wherein each switch is a press switch.

9. The electronic clock as claimed in claim 1 wherein each switch is a press switch is a touch panel.

10. The electronic clock as claimed in claim 1, wherein the clock module includes at least one illumination module electrically connected with the clock module and used to illuminate the at least one display panel.

11. The electronic clock as claimed in claim 10, wherein each illuminating module has a second adjusting button for turning on/off each illuminating module and for adjusting a brightness of each illuminating module.

12. The electronic clock as claimed in claim 10, wherein each illuminating module is comprised of any one of a LED light and a light emitting element.
